(19) United States
(12) Patent Application Publication
(10) Pub. No.: US 2021/0322842 A1
(43) Pub. Date: Oct. 21, 2021

(54) Baseball Safety Target and Performance Training System

(71) Applicant: Grant Mydland, McLean, VA (US)

(72) Inventor: Grant Mydland, McLean, VA (US)

(21) Appl. No.: 17/230,746

(22) Filed: Apr. 14, 2021

Related U.S. Application Data
(60) Provisional application No. 63/010,238, filed on Apr. 15, 2020.

(51) Int. Cl. A63B 69/00; G09B 29/00; G09F 17/00

(52) U.S. Cl. CPC A63B 69/0002; G09F 17/00; G09B 29/00

(57) ABSTRACT

A baseball and softball training and performance system and set are disclosed. The system and set may include a home plate and/or other bases disposed on a field or in a training area, and a mat or stenciled target near the home plate. The home plate and mat or stenciled target may have identical or common text and/or graphic elements communicating a safety and/or performance message and providing a target symbol to remind a player to place a bat on the mat or stenciled target. The system may further include one or more of a banner, ball, helmet, bat, or other equipment and accessories having an identical or common text and/or graphic elements communicating the safety and/or performance message and providing the target symbol. The home plate may be an expanded strike zone home plate.

### FIELD OF THE INVENTION

Embodiments of the present invention relate to safety target and performance training for baseball and softball.

### BACKGROUND OF THE INVENTION

According to a 2019 study by the Sports and Fitness Industry Association (SFIA) the amount of people who played baseball within the United States rose 21 percent from the year 2014 to '18, or approximately 15.9 million people overall spanning all age groups. For the third consecutive year, baseball and softball combined to be the most participated team sport in the U.S. with 25.6 million participants. Nearly 15 million of those were “core” players who played 13 or more times in a year. The Aspen Institute's State of Play 2019 report found 4,100,000 children ages 6-12 played baseball and 359,000 regularly played softball. These referenced materials are available at: https://www.mlb.com/news/baseball-participation-increases https://www.aspenprojectplay.org/youth-sports-facts/participation-rates The safety of participants and spectators in youth sports is a growing concern as awareness of the dangers of injury, and concussions, increases. There are products available to protect participants and spectators from injury caused by the two types of projectiles that are part of the game, namely balls and bats. These existing products, which include helmets, guards, padding, reinforced clothing, and the like, may limit the amount of injury sustained following an impact between a player and a projectile. Few, if any, safety products are designed to prevent player-projectile impact in the first place. And there is no system to help leagues, coaches, trainers, umpires, players, and parents standardize bat and ball safety training and compliance.

Baseball and softball injuries are more common today because kids are playing more, practicing more, and often playing year-round. The explosion of Travel League baseball programs across the United States and Major League Baseball's Play Ball youth initiative that was launched in 2015 have helped significantly increase participation in baseball and softball. Even before this significant increase in participation, it was reported that more than 110,000 children in America are treated each year for baseball-related injuries, usually related to being hit by a ball (46%) or bat (25%). It is believed that many more injuries may go unreported since most injured players are treated on the field or at home and never go to the emergency room. One such report is available at: https://www.nationwidechildrens.org/research/areas-of-research/center-for-injury-research-and-policy/injury-topics/sports-recreation/baseball-related-injury

Youth leagues recently responded to the increase in the number and severity of injuries by changing bat standards in 2018. USA Baseball, which is the national governing body for the sport of baseball in the United States, adopted a new method for measuring bat performance in the testing of youth bats that went into effect on Jan. 1, 2018. The new USA Baseball bat standard (USABat) was developed by a USA Baseball committee of scientific experts. The new bat standard addresses the potential injury to participants due to the “liveliness” or speed of the batted ball back towards the players, umpires, and others in or near the field of play.

The new USABat standard did not address the likelihood or severity of an impact between a bat and anyone nearby resulting from a thrown or carelessly swung bat. Regardless of the type of bat, it is imperative for the overall safety of the game to teach bat safety comprehensively (i.e., whenever a bat is handled), precisely (i.e., with repeatable results), accurately (i.e., using a standardized approach that can be taught throughout baseball and softball), and uniformly (i.e., promoted throughout baseball and softball at all levels). Two examples of modeling behavior (MLB's and college baseball's mandatory use of batting helmets and prohibition of tobacco products) successfully demonstrate how rejecting old school mentalities and using new approaches throughout a sport can lead to decreasing injuries and unsafe habits at all levels.

The study cited above showed 25% of injuries were bat-related while 46% are ball-related. While some injuries result from a combination of bat and ball, many ball-related injuries occur from unsuspecting fielders, base runners, and batters that are struck by a thrown ball. Most ball-related injuries are sustained by infielders (34.7%), batters (27.9%), and outfielders (12.1%). A wide variety of safety balls are currently used in youth baseball. These include tennis balls, rubber balls, plastic balls, and cloth balls that are used for specific training purposes and create less injuries than normal baseballs. A special type of ball commonly known as the reduced-impact ball (also known as the Reduced Impact Factor or RIF ball) has been used for years. The RIF ball is designed to look and play like a regular baseball but has greater deformation on impact than traditional balls, lowering the force transmitted to the player. RIF balls generally have a polyurethane core, in contrast with the wool yarn wound around a cork core in the traditional baseball. There are three main types of RIF balls: reduced-impact 10, reduced-impact 5, and reduced-impact 1. Type 10 is stiffer (harder) than type 5, which is stiffer than type 1. There are many studies that investigate ball-related injuries and mitigation factors. One such study is available at: https://jamanetwork.com/journals/jama/fullarticle/195892

An NBC News investigation in October 2019 found at least 808 reports of injuries to MLB fans from baseballs from 2012 to 2019. The injuries include concussions and permanent vision loss. In 2018, a grandmother celebrating her 79th birthday at Dodgers Stadium in Los Angeles died after being hit in the head by a foul ball. In 2018, as more spectators were at risk of getting injured or killed from foul balls, broken bats, or bats that had slipped out of players hands and hurled into the stands, all Major League Baseball (MLB) teams extended their netting around home plate—from dugout to dugout. In December of 2019, baseball commissioner Rob Manfred announced by the end of next season every MLB team would have expanded netting down foul lines to protect fans. The MLB Players Association has twice called for netting from foul pole to foul pole, modeled after Japanese baseball stadiums. Injured spectators have a major impediment to legal actions against MLB teams due to liability protection under the so-called “Baseball Rule,” a legal doctrine dating back to the early 1900s that makes it difficult for spectators to sue professional teams over injuries. A disclaimer on the back of every ticket reads that “the ticketholder assumes all risk, danger and injury incidental to the game of baseball . . . ” Fewer liability protections exist at lower levels of baseball especially where no ticket is purchased. Baseball and softball leagues, from college down through Tee Ball, would benefit from additional consideration of how to improve spectator safety from foul balls and broken or thrown bats at their fields. There is no existing baseball safety target and performance training system that would enable leagues to standardize, promote, brand, and implement a systemic solution throughout baseball and softball. There are many articles on ball-related injuries and mitigation factors. One such article is available at: https://www.nbcnews.com/news/sports/we-re-going-need-bigger-net-foul-balls-hurt-hundreds-n1060291.

Players need to learn how to do many things to play effectively and safely from simply handling a bat, taking practice swings away from the batter's box, dropping a bat safely after leaving the batter's box, to learning how to properly avoid a wild pitch, remain in controlled and distanced lines during warm-up ball toss, and only throwing a ball to another fielder that is ready to receive the ball. To teach these and other skills, baseball and softball leagues, coaches, managers, umpires, personal trainers, parents, and participants need a comprehensive safety target and performance training system. Bat safety training is particularly lacking, and it is common for excited youth hitters to carry their bat all the way to first base. Players and coaches especially, but any participant can get injured when a bat or ball is carelessly handled. Players, umpires, coaches, trainers, parents, siblings, and others have been and may be injured from thrown and tripped over bats, careless practice swings, uncontrolled throws, and wild pitches. Teaching hitters the importance of: controlling bats (including while not in the batter's box), handling bats only by the barrel not the handle to control the dangerous end of the bat, never taking a practice swing before checking if someone is behind them, not swinging a bat at practice unless the coach has determined it is okay, dropping them safely before proceeding to first base, and never excitedly throwing them where they may present a clear danger to catchers, umpires, coaches, trainers, and others on the field, is paramount. Teaching players to focus on throwing a ball under controlled circumstances is also central to protecting everyone who participates or attends baseball and softball games and practices. Leagues require participants to sign waivers to prohibit families from suing the organization in case of injury, but lawsuits are filed anyway requiring expensive legal fees. There are few or no waivers signed by individuals just passing by the ball field or by general spectators (without a direct tie to the league) and none are known limiting liability between players and other players. Incorporating standardized safety training methods to reduce injuries would decrease ill feelings between league families—especially when carelessly tossed or swung bats and uncontrolled thrown balls are involved. Injuries certainly play a role in a player and family's decision to register for the next season and local press coverage of serious injuries can also decrease league and sport participation.

Baseball is a complicated sport. The 2020 Official Little League® Baseball Rule Book includes over 200 pages of official regulations, playing rules and policies. Coaches are expected to know the basics—and commit to learn the rules—of the game; follow policies on player skills development, safety, and health; motivate players to learn the basics, key rules, and strategies; and manage practices and games to lead to a successful season. Studies show over 90% of amateur coaches in this country get little training beyond a two- or three-hour free league clinic, usually sponsored by a regional organization. These free clinics are not mandatory and there is no certification requirement like in other youth sports (e.g., USA Hockey). Most youth baseball coaches rely on reference materials they find to the extent that they are often known as “YouTube coaches” as they surf the web for drills, “how-to” tips, and advice. Many are just thrown into the job because they might have played baseball in their youth and are now expected to figure everything out on their own since underfunded and understaffed leagues do not have the ability to create, train, and monitor standardized programs to build skills and increase safety. Safety is a key challenge due to the myriad of potential issues, trying to control the situation (e.g., other players, spectators, etc., when injuries do occur), and most importantly addressing the specific injured player(s) or other participants. Leagues list safety issues in their materials but, beyond a few dedicated programs (i.e., First Aid training, preventing child abuse) and guidelines including having medical release forms at each team activity and how to handle inclement weather, coaches are often left to their own on how they learn about and manage safety on their team. Far too often, the first opportunity to discuss a major safety issue is after-the-fact, which means the coaches, team, and other participants were not prepared for the new experience (e.g., serious facial injury, freak storm, or bizarre occurrence including a non-team member getting injured near the bleachers).

Repetition can be the key to success in any sport—especially baseball and softball. There are many coaching keys parents can provide to reinforce and help their child develop appropriate skills at home. Parents today often rely on their own sports experiences from many years ago and from the Internet, which can provide useful information sometimes and misinformation other times regarding tips, drills, and skills. The limited time many parents can spend with their child due to other commitments may be squandered when they receive potentially flawed information. Parents need reliable sources of vetted information and constructive tools to utilize with their child.

Historically, youth sports leagues are continually underfunded and depend on fundraising and sponsors to generate enough revenue to sustain operations. Participation in youth sports goes in cycles, including age-appropriate population bubbles, but are also impacted by societal trends, and as we learned in 2020—a pandemic health crisis. Maintaining confidence in baseball as a family friendly and safe sport is a priority and opportunity for growth as football and other sports contend with decreased participation due to higher rates of CTE, concussion, paralysis, and other serious injuries. Incorporating safe practices and guidelines in response to Covid-19 had a significant impact across the country as leagues and communities were able to continue playing baseball and softball, after delays, while other sports were canceled.

Skills development is an area across all sports that has seen a significant increase in the need to foster performance due to the bigger, faster, and more agile athletes today compared to decades ago. The days of stick, whiffle, and sandlot ball have been replaced with organized leagues filled with anxious parents and players looking to learn America's most popular youth sport. Many now play year-round in advanced travel leagues and may even play on the same team together for up to eight years (7U through 14U) and beyond as they enter higher levels of play. While performance expectations are high, coaches have very limited time to practice with players. A volunteer coach's desire to acquire, cypher through, and convey helpful instructional skills development material is very difficult—especially with a lack of available external cue teaching aids and methods to help standardize, simplify, and reinforce verbal coaching. Private or personal trainers who may or may not work out of advanced training facilities are always looking for the newest training aid to increase performance and attract and keep clientele. Having easily portable equipment and training aids make the trainers job much easier. Training aids that utilize external cues to help explain and reinforce key coaching and training objectives are part of some of the newest trends in private training and improved performance attainment.

Although widely popular and dubbed America's pastime, baseball can be boring. Especially for 5 to 8-year-olds trying multiple and more fast-paced sports (i.e., soccer, basketball, football), with siblings and friends who want to play tag or four-square, and technology companies focused on funneling these future consumers into mobile devices and video games, who then have to contend with waiting a couple innings to hit and possibly getting stuck in right field. The game can often be slow and drag on with long stretches where players never touch the ball or swing a bat. And then they may only hit or be involved in a play two or three times over the entire game. MLB has reacted to fans “slow and boring” complaints by limiting mound visits, shortening breaks between innings, forcing pitchers to face at least three batters to reduce pitching changes, and is considering a pitch clock (already utilized at lower levels) to speed up play. Recreational leagues also know a player that is bored during a game is probably not going to want to come to practice or organize spontaneous pickup games with friends that are vital to increasing interest in and dedication to the sport.

The substantial increase in private training facilities has created another significant need in the marketplace. From a simple batting cage tied to a municipal park decades ago to million-dollar indoor facilities with state of the art measuring devices, pitching machines, multi-use batting cages, professional instruction, and strength and conditioning programs, the demand for the latest and greatest tools and methods are key to running a professional operation. Recreational and travel leagues as well as parents seeking the best options for their supposedly scholarship bound children has increased the demand for private training facilities. Training facilities can get very busy with players, trainers, parents, and others milling around the facilities. Tools that address safety at these facilities are key for many reasons aside from injuries and lawsuits. The amount of activity occurring at them necessitates innovative and comprehensive safety practices and performance tools.

There are many factors that require individual instruction and/or practice without supervision from a team or private coach. These factors include diversity of instruction from other sources (e.g., web-based training and tips), differences in learning skills and improvement progress, motivation, determination, enthusiasm, length of time with a team, injury or illness, parents driven to pursue any option to help their child succeed, and even closure of public and private accessible park and recreation facilities due to budget reprioritization or as many government authorities did during the Covid-19 health crisis.

In view of the foregoing, there is a need for a safety target and performance training system to help baseball and softball organizations more effectively manage sport safety and increase performance, participation, and enthusiasm. A system to increase the familiarization, preparedness, and standardization for leagues, coaches, umpires, players, and other participants to proactively address and handle expected safety, skills development, and enjoyment issues that teams are likely to face. The priority should be a standardized system to help the tens of thousands of volunteer coaches who often rarely get the requisite training they need for safety and skills development issues they will face. Secondly, players transition to new sports, levels, teams, and coaches for many reasons which can add complexity to mixing participants with varying age, size, skill, and interest levels. A standard system to teach players will help them convey the importance of safety and performance to new coaches and be an enthusiastic example to first-time players. Thirdly, a safety target and performance training system that permits parents, and all participants, to continue training and skills improvement at private training facilities and on their own may be key to long-term success of each participant and the sport. Still further, there is a need for a system to be used by league organizations that often deal with multiple communication challenges, to have better and standardized tools and programs to instruct and monitor skills development and compliance with safety programs designed to decrease injuries, help coaches and players serve as examples to all participants, motivate players and families to participate in their sport, and increase sponsor-based fundraising and partnering opportunities vital to league operations and survival.

### OBJECTS OF THE INVENTION

Accordingly, it is an object of some, but not necessarily all embodiments of the present invention to provide a safety target and performance training system to increase safety and enthusiasm in both baseball and softball.

It is also an object of some but not necessarily all embodiments of the present invention to provide target and signaling methods to standardize safety training, monitoring, and compliance for the safe handling of bats inside and outside of the batter's box, balls all over the field, and to help clarify and improve the roles of all participants.

It is also an object of some but not necessarily all embodiments of the present invention to provide equipment that supports standardized safety training and skills development instruction, possibly even with the development of a certification requirement in cooperation with leagues and other partners, to help clarify and improve the roles of all participants.

It is another object of some, but not necessarily all embodiments of the present invention to provide a target and/or signaling methods for increasing safety and performance that is amenable to branding and messaging materials and partnering opportunities to constantly reinforce safety and skills development throughout baseball and softball.

It is another object of some, but not necessarily all embodiments of the present invention to develop the safety target and performance training system symbol into a “Good Housekeeping Seal of Approval” for baseball and softball related items.

### SUMMARY OF EMBODIMENTS OF THE INVENTION

Responsive to the foregoing challenges, Applicant has developed an innovative and standardized safety target and performance training system incorporating “external cue” training tools and methods that serve as teaching aids in addition to verbal coaching. Like a STOP sign for drivers—reminding them to stop, embodiments of the safety target and performance training system symbol may a) signal the importance of always handling a bat by the barrel, and vertically instead of horizontally, when not in the batter's box to “control the dangerous side of the bat”; b) never take a practice swing before checking if someone is behind them; c) reinforce the key message “Safety Before 1ST” to emphasize “safety before heading to 1ST base”; d) draw attention to home plate and base running actions to consider in the batter's box; e) remind the batter not to throw a bat and instead drop it safely to avoid injuries and play interference penalties; f) reinforce how to properly avoid a wild pitch; g) remind players to remain in coordinated and distanced lines during warm up ball toss to avoid hitting teammates and coaches; h) remind players to never throw a ball at another fielder that is not (or getting ready) looking at you; and i) learn to be their own best coach by using tools and methods to increase performance including being more aggressive while batting, pitching, or catching pursuant to the game's unwritten rule of an expanded strike zone (ESZ). Embodiments of the invention may prevent lawsuits and ill feelings and motivate parents to choose baseball or softball as a safer sport for their child thereby increasing baseball and softball league participation. Embodiments of the invention clarify often unwritten or at least misunderstood rules regarding the ESZ used in youth baseball (clarifying that one ball on either side of home plate—since a portion of the ball grazes the outside border—is an official strike at all levels of baseball and the additional ball outside the regulation strike zone—two ball widths from the home plate border) will increase player enthusiasm for the game since it encourages aggressive hitting which leads to improved performance and more action for all players and spectators. Embodiments of the invention help players understand the intricacies of the strike zone, how to increase performance when hitting inside, down the middle, and outside pitches; the probable trajectory of balls hit correctly in specific areas of the strike zone; as well as pitching to and catching in the areas in and outside of the strike zone.

Applicant has further developed a system and methods that incorporate multiple and diverse products and locations on which a safety target and performance training system symbol(s) may be placed for safety and performance message reinforcement, including without limitation on multiple surfaces such as field and facility equipment (home plate and bases and their halos; custom padding, dugouts and clubhouses; screen, net, cage, and fence systems), grass fields where grass is grown between base paths, catcher's box, and dugouts; dirt fields where there is no grass between base paths, catcher's box, and dugouts; and synthetic fields which have synthetic turf over the entire field of play and foul territory inside the fences. Embodiments of the invention may also reduce the potential adverse impact of weather conditions on the safety target and performance training system components and adheres to specific league guidelines on the restriction of potential trip and fall hazards during games. Embodiments of the safety target and performance training system may be provided in the form of symbols, banners, mats, stenciling utilizing marking paints specific to the field surface, home plates, decals/emblems/stamps for bats, helmets, and balls, downloadable PDFs for parents to use with their child away from practices and games, through virtual displays including projected images, and on products and wristbands. Embodiments of the invention may also be provided by equipment manufacturers, sponsors, and other partnering organizations.

It is to be understood that both the foregoing general description and the following detailed description are exemplary and explanatory only and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only and should not be construed as limiting the invention.

FIG. 1 is a top view of a first symbol, banner, mat, and/or decal/emblem/stamp that are part of a safety target and performance training system in accordance with embodiments of the invention.

FIG. 2 is a top view of a second banner, mat, and/or decal/emblem/stamp that are part of a safety target and performance training system in accordance with embodiments of the invention.

FIG. 3 is a top view of a stencil that is part of a safety target and performance training system in accordance with embodiments of the invention.

FIG. 4 is a perspective view of a synthetic (rubber and/or vinyl) mat that is part of a safety target and performance training system in accordance with embodiments of the invention.

FIGS. 5A and 5B are illustrations of home plates that are part of a safety target and performance training system including symbols and an expanded surface area in accordance with embodiments of the invention.

FIG. 5C is a top view of a home plate training mat that is part of a safety target and performance training system including symbol and an expanded and extended surface area in accordance with embodiments of the invention.

FIG. 6 is a top view of printable banners, mats, decals/emblems/stamps, and home plates that are part of a safety target and performance training system in accordance with embodiments of the invention.

FIGS. 7A, 7B, 7C, 7D and 7E are illustrations of safety target and performance training system components, including symbols, banners, mats, and/or stencils, as deployed on a ball field or virtual display including projected image in accordance with embodiments of the invention.

FIGS. 8A, 8B, and 8C are illustrations of safety target and performance training system symbol reinforcement decals/emblems/stamps as provided on examples of the types of baseball and softball equipment and accessories that are part of a safety target and performance training system in accordance with embodiments of the invention.

FIGS. 9A and 9B are illustrations of a wristband that is part of a safety target and performance training system in accordance with embodiments of the invention.

### DETAILED DESCRIPTION OF EMBODIMENTS OF THE INVENTION

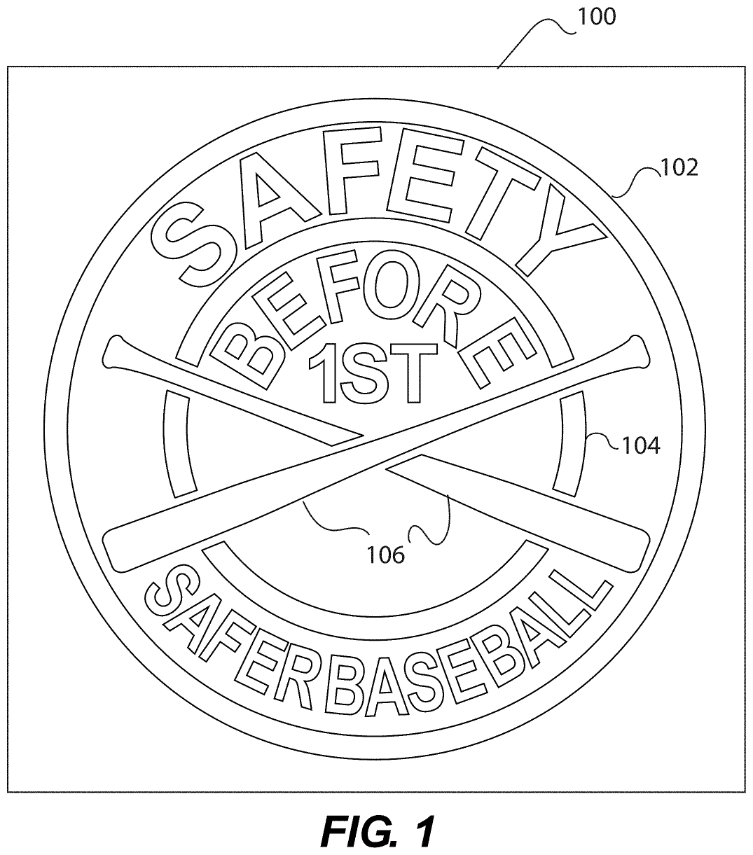

Reference will now be made in detail to embodiments of the present invention, examples of which are illustrated in the accompanying drawings. With reference to FIGS. 1, 3, 4, 5A, 5B, 5C, 6, 7A, 7D, 7E, 8A, 8B, and 8C embodiments of the safety target and performance training system and methods invention may include a banner, decal/emblem/stamp 100 including graphic and/or text elements which communicate a safety message. The graphic and/or text elements may include a target symbol such as a bullseye target with rings 102 and 104 drawing the attention of the batter. The bullseye target may include two crossed bats 106 to aid the batter to “aim for the X,” possibly even including that message. The text information may include the term “SAFETY” to alert the batter to the vital message of safety. The text information may further include the phrase “BEFORE 1ST” to call attention to batters' actions before hitting the ball and proceeding to 1ST base. The text information may further include “PERFORMANCE”, or other similar wording, to draw attention to the key instructional cues and tips that are elements of the safety target and performance training system. And the text information may still further include the phrase “SAFER BASEBALL”, with or without .com or .org, to identify the source of the safety equipment as well as to provide a common identifier for all elements of the safety target and performance training system so the batter will have a safety message reinforced each time the common identifier is observed. The “SAFER BASEBALL” text, with or without .com or .org may also direct the batter and others to a common location for additional safety and performance information and coordinate branding throughout youth baseball and softball.

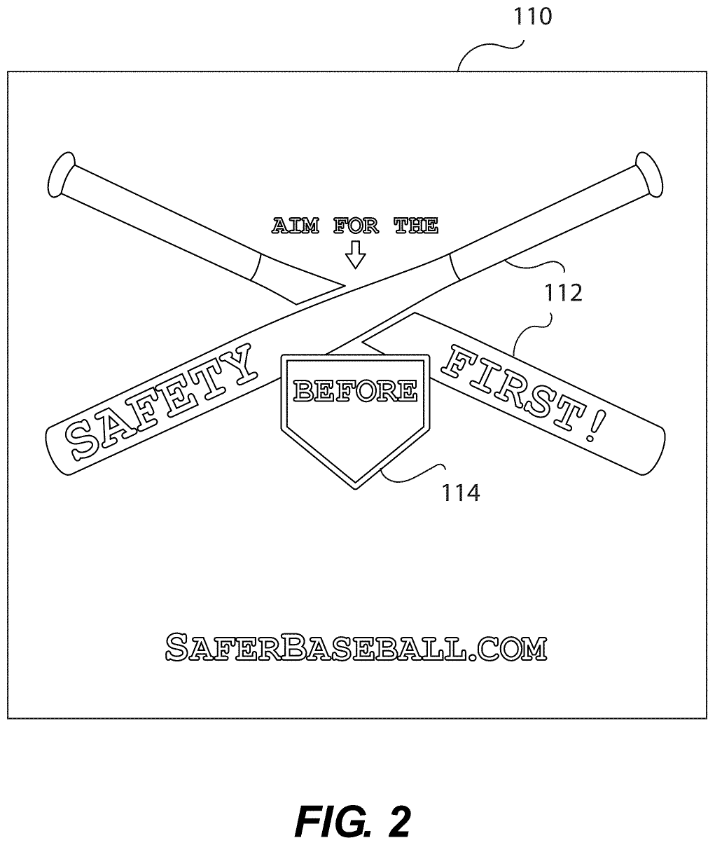

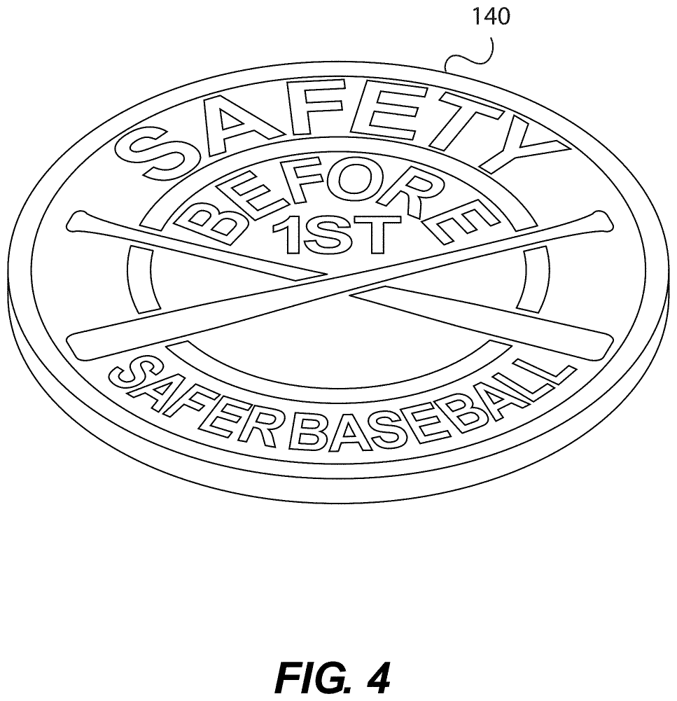

FIG. 4 illustrates a most likely circular synthetic (rubber and/or vinyl) mat 140 that may be used in coordination with, or in lieu of, the rectangular banner mat 110 shown in FIG. 2 in accordance with embodiments of the safety target and performance training system, set and method. The circular synthetic (rubber or vinyl) mat 140 may be smaller (most likely 24 inches in diameter) than the banner mat, easier to deploy, more durable, foldable, yet hold its shape, and made of a one-piece synthetic mat that most likely is 3.175 to 6.35 mm (⅛ to ¼ inch) thick. The safety target and performance training system synthetic mat 140 may be constructed from sturdy rubber or vinyl to resist weather and withstand athletic use, stand up to years of outdoor use, may reduce the likelihood of slipping on wood floors during indoor use and may have a relatively large version of the safety target and training target symbol dyed into a rubber material or printed between multiple layers of vinyl. The synthetic mat 140 may be designed for use in the lower age youth baseball and softball levels where they will be placed on the playing field during practice only not, unless the league organizations approve their use, during games. Since players begin playing baseball and softball at different age, athletic skill, and interest levels, it is preferred to standardize and brand the safety target and performance training system components throughout all levels of baseball and softball to ensure these new entrants get the critical safety training they need as well as serve as a constant external cue to all participants. Though most begin playing baseball with Tee Ball or Single A, there are a myriad of reasons that have players entering baseball at AA, AAA, and even Majors levels. For example, a big and athletic 11-year-old basketball player may be eligible for Majors after never playing organized baseball or softball. The potential injuries from him carelessly throwing or handling a bat or ball must be considered. The synthetic mat 140 can be a valuable contribution to the safety target and performance training system and methods that permit private trainers, parents, and all participants, to facilitate individual instruction and/or practice without supervision from a league or team. The synthetic mat 140 may be deployed on a field or training area (e.g., multi-sport facility, gym or indoor sport training facility, or the like) during practice near home plate along the outside of the first base line, preferably no more than one third of the distance away from home plate along the base line but clearly in foul territory to minimize interference with typical play. The synthetic mat serves as a visual reminder and target for safely dropped bats by players.

With reference to FIGS. 2, 6, 7B, 7C, and 7E in which like reference characters refer to like elements, embodiments of the safety target and performance training system may include a second type of banner and/or mat 110, decal/emblem/stamp. The second type of banner and/or mat 110, decal/emblem/stamp, and virtual advertising may include two crossed bats 112 and may include the text “AIM FOR THE” to aid the batter to aim for the crossed bats. The text information may further include the message “SAFETY BEFORE FIRST” where the terms “SAFETY” and “FIRST!”, each may appear on a bat graphic 112. The term “BEFORE” may be provided on a home plate graphic 114, to alert the batter to the key message. The text information may further include “PERFORMANCE”, or other similar wording, to draw attention to the key instructional cues and tips that are elements of the safety target and performance training system. The text information may further include “SAFER BASEBALL,” with or without .com or .org, to identify the source of the safety equipment as well as to provide a common identifier for all elements of the safety target and performance training system so that the batter will have a safety message reinforced each time the common identifier is observed. The “SAFER BASEBALL” text may also direct the batter and others to a common location for additional safety information and coordinate branding throughout youth baseball and softball.

The safety target and performance training system banner and/or mat 110 will preferably, but not necessarily, be square in shape to leave room for league, sponsor, and partner logos. In one embodiment, the banner and/or mat 110 may be 36″×36,″ made of approximately 16-ounce banner (vinyl) material for weathering durability, storable, and portable benefits; most likely only printed on one side; may be on a white background for best differentiation with league, sponsor and partner logos; may have grommets in each corner to facilitate hanging on fences but not used for anchoring on field surface where groundskeepers would resist such disruption to playing field; may have 2″ diameter pole pockets at the top and bottom to insert weighted down options (e.g., 30″ 1-inch PVC pipe, 30″ rubber hose filled with sand) to minimize movement in windy conditions. As with the synthetic mat 140 shown in FIG. 4, the mat 110 may be deployed during practice along the outside of the first base line, preferably no more than one third of the distance away from home plate along the base line, but clearly in foul territory to minimize interference with typical play, to serve as a target for safely dropped bats by players.

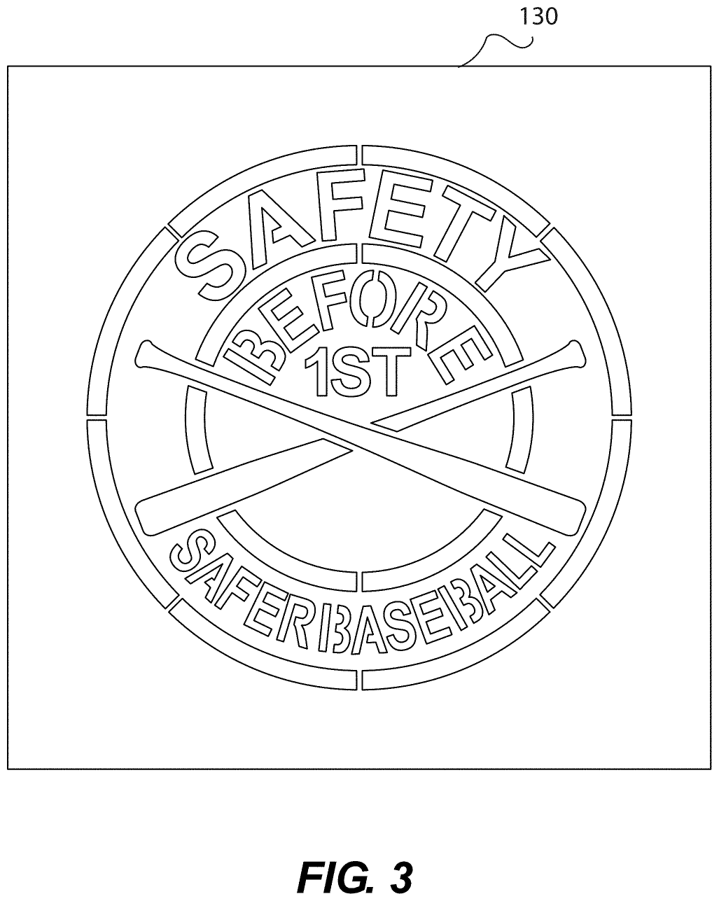

With reference to FIG. 3, a stencil 130 having all the graphic and text elements of the FIG. 1 safety target and performance training system symbol 100 is illustrated. A stencil may include for the purposes of this application, without limitation, projected images using a light source. The stencil may preferably have a 38″ diameter traced out on a durable 40″×40″ square yet foldable one-piece UV stable plastic that most likely is 8 mils thick. Stencil letters should be between 4″ to 6″, most likely 5″ to facilitate the connected letters (A, R, and Bs in the design) that are more challenging to be read with field marking paint application so that necessitates the 5″ desired minimum. For best performance, the stencil 130 should be used with appropriate field marking paints (engineered for natural grass or synthetic fields). The stencil 130 may need to adhere to league, county, local, and school recreational field approved standards. As with the synthetic mat 140 shown in FIG. 4, the stencil 130 may be used to create a painted target along the outside of the first base line, preferably no more than one third of the distance away from home plate along the base line, but clearly in foul territory, to serve as a target for safely dropped bats by players.

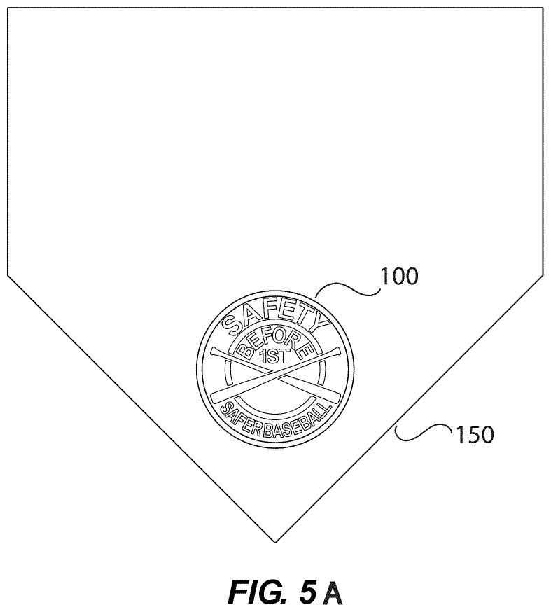

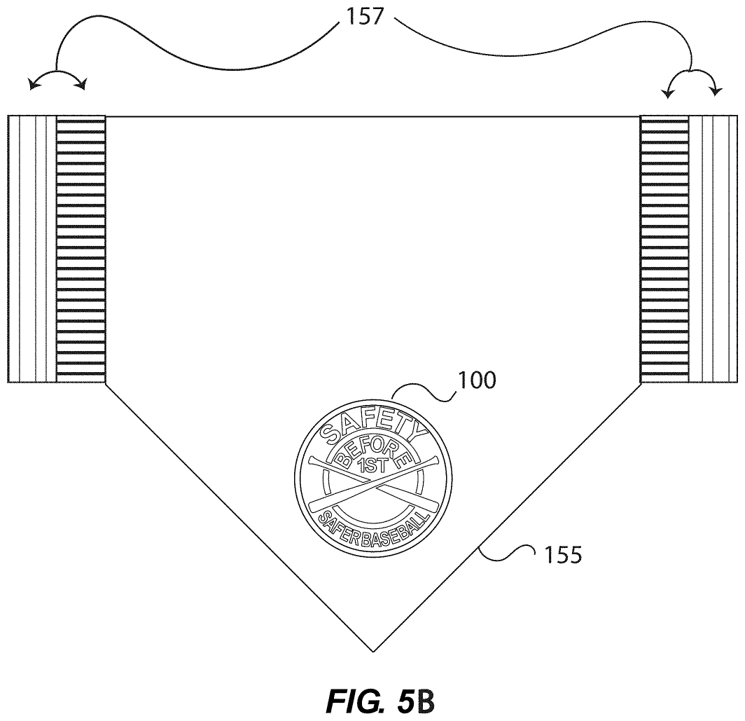

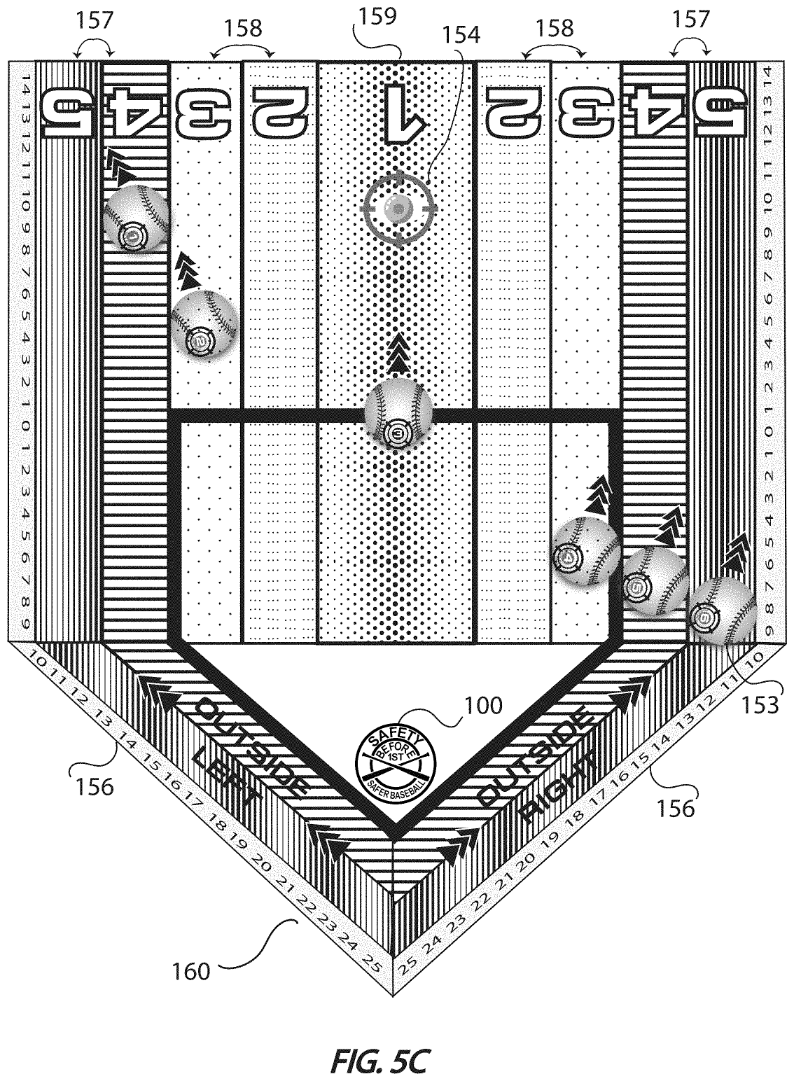

FIG. 5A illustrates a home plate 150 that may be used in coordination with, or in lieu of, the rectangular banner mat 110 shown in FIG. 2 or synthetic (rubber and/or vinyl) mat 140 shown in FIG. 4 in accordance with embodiments of the safety target and performance training system and methods. The home plate 150 may have the standard thickness of a home plate (1 to 3 inches). The home plate 150 may have a relatively small version of the safety target and performance training target symbol 100 deeply dyed into the white rubber home plate material. A safety target and performance training symbol 100 decal/emblem/stamp preferably is not simply applied to an existing home plate since the graphic may peel/rub off due to cleats, bats, catcher's, and field maintenance equipment scratching across the surface of the plate.

FIG. 5B illustrates a home plate 155 with an expanded strike zone (ESZ). Many youth leagues use an expanded strike zone adding an additional ball width to the opposite side of the batter beyond a full ball width from the border of the regulation 17″ wide home plate since that ball—grazing the outside of the plate—is already a strike at all levels of baseball yet confusing to most youth batters who think only a ball directly over the plate is a strike; armpits to bottom of knees rather than chest to top of knees; etc., to encourage aggressive hitting, build pitcher confidence, reduce pitch counts, and (open to interpretation) make for a more exciting game since an expanded strike zone encourages more swinging which means more chances for contact requiring defenders to be more alert and decreases player and spectator boredom. Applicant is not aware of any home plate that exists today dedicated to effectively train batters to react to the expanded strike zone. Therefore, a batter often is presented with a strike zone that is left to broad interpretation by the umpire. This expanded strike zone (ESZ) home plate can be a valuable contribution to the safety target and performance training system and methods that permit parents, and all participants, to supplement team or personal coaching and training. In fact, Applicant calls attention to and prioritizes one of baseball's truisms, “consistently and successfully hitting a moving round ball with a round bat” is the most difficult task in sports. Applicant stresses the attitude and skills development necessary to increase performance and turn batters into hitters. Although extend and expand can be used interchangeably in some contexts, extend applies to things that are being stretched out, while expand applies to things that are spread out. One implies length, the other area. Throw down ESZ home plate 155 may be easier to deploy, more durable, foldable, yet hold its shape, synthetic mats that are 3.175 to 6.35 mm (⅛ to ¼ inch) thick and may have the safety target and performance training symbol 100 deeply dyed into the rubber material or printed between multiple layers of vinyl. The ESZ home plate 155 for youth specific fields has a clearly delineated expanded strike zone 157 on each side of the plate to aid the batter and pitcher and help the league, coaches, parents, and personal trainers encourage more aggressive hitting and increase enthusiasm for all participants.

Most quality coaches tell their players that “they are their own best coach” to encourage them to put more effort and time into developing their skill set. It is very apparent in baseball when a batter must react to various pitchers and their own reactions while at the plate. Coaches should not impede the game by coaching on every pitch. Coaches are also advised to leave the coaching to practices and “just let kids play” during games. Tools designed to aid athletes in their self-coaching and self-training are becoming more available. Research shows that over 70 percent of strikes cross between the middle of the plate and the regularly called outside strike (one ball width off the border of home plate). The expanded strike zone umpires utilize possibly results in over 75 percent of strikes called for pitches that cross between the middle of the plate and the expanded outside ball width zone which is two ball widths from the border of the standard home plate. Youth batters need to learn how to hit the outside pitch to be more effective, have fewer strikeouts, and help their team succeed. Some of the greatest hitters in the game (from Hall of Famer Tony Gwynn to the top-rated player in today's game Mike Trout both mastered hitting the outside pitch first, focusing on hitting the ball to the opposite field, and make it a critical part of their pre-game warm-up to become dominant hitters. It is much easier to pull an inside pitch down the line than it is to consistently hit an outside pitch to the opposite field. Finally, baseball is often claimed to be the most singular team sport because of individual actions—especially when a pitcher statistically has an approximate 70 percent success rate against the batter. Increased success at the plate brings more smiles to anxious parents worried about their child's performance, more alertness of defenders often standing around waiting to engage in a ball hit to them, and to spectators yearning for more action and offense. With many youthful players fearing the strikeout and especially a called third strike without swinging, they would be thrilled to have a tool to increase their skills, confidence, and performance. For best performance, the expanded home plate 155 may have two 2.9″ wide differently colored or shaded areas on either side of the plate that will increase the overall standard 17-inch width of home plate to 28.6 inches). The differently colored or shaded areas equal a total increase of 11.6 inches since youth umpires do not utilize the inside 2.9-inch area closest to the batter for the ESZ to discourage inside pitching to young players. The expanded home plate 155 may have the safety target and training symbol 100 dyed into the rubber material or printed between multiple layers of vinyl. If permitted to become official replacement home plates, the expanded home plate 155 may help decrease the amount of confusing, umpire-specific interpretable strike zones for the benefit of hitters and increase enthusiasm for all participants. These more permanent expanded home plates 155 preferably would be the standard thickness of a home plate (1 to 3 inches). The expanded home plate 155 may be used for softball too with the consideration that softball utilizes three different size regulation (11-inch, 12-inch, and 16-inch) balls.

FIG. 5C illustrates the Expanded Strike Zone (ESZ) Training Mat for Hitters, Pitchers, and Catchers 160. The ESZ training mat 160 may have two 2.9″ wide (approximate diameter of a baseball) differently colored or shaded Expanded Strike Zone 157 areas on either side of the plate that will increase the overall standard 17-inch width of home plate to a maximum of 28.6 inches. There may be five or more additional differently colored or shaded areas 158 covering the width of home plate to help train pitchers and catchers dial in to specific strike zone target areas for their inside and outside pitches. Four of these additional 158 sections may have the same 2.9″ width as the outside sections while the middle section 159 over the center of home plate will be approximately 5.8″ and may be differently colored or shaded than all the other sections. Including the four expanded home plate sections, all nine of these sections may be numbered facing the pitcher. The center section 159 may be numbered 1 and the four to the right and four to the left could be numbered 2, 3, 4, and 5. The five sections (numbered 1-3) may extend from the center of home plate to the top of the ESZ training mat 160 with the lower triangle section of home plate possibly remaining white. The four expanded home plate sections (numbered 4 and 5) 158 are outside the border of home plate and run from the bottom to the top of the mat. The ESZ Training Mat for Hitters, Pitchers, and Catchers 160 may have numbered balls (#1, #2, #4, #5 and #6) 153 that can be in red numbers for right-handed batters and blue for left-handed batters. The #3 ball can be black and is for both right- and left-handed batters. There can be targets on all the balls 153 to signal the optimal location for the batter to aim for while hitting the ball and directional arrows to help batters know the most likely trajectory of those balls when the target area is hit with the correct swing path. This creates a three-dimensional (3D) training aspect to the ESZ training mat where batters can place a tee over a specific ball 153 to work on hitting inside, down the middle, and outside pitches. A graphic, possibly an eye 154 within a target, may be placed just below the #1 in the center section to guide the batter to keep their head steady while swinging and angled to that area while keeping their eyes on the pitched ball. Stance and Stride Guide measurement markers 156 can be included along the outside border to help hitters determine and repeat foot placement that works for their specific swing. Possible configurations for the measurement markers 156 include putting “0” across from the top of the plate and numbers (1-14) continuing up to the top of the mat while numbers (1-25) continue to the bottom of the mat. Graphic Text Bubbles can be used to identify specific aspects of the ESZ training mat 160 and Tips Boxes (possibly including “Tips for All Players”, “Pitchers Tips”, “Hitters Tips”, “Catchers Tips”) may be placed directly on the mat (front or back of mat) or be included separately as flash cards or website material (possibly linked via a QR scanned code if feasible) to provide quality and consistent instruction on the fundamentals of key positions in relation to the ESZ training mat. The throw down ESZ training mat 160 will preferably, but not necessarily, be in the shape of home plate but may be approximately 40″ long×29″ wide, made from 3.175 to 6.35 mm (⅛ to ¼ inch) thick synthetic material (rubber or vinyl). If rubber, the safety target and performance training symbol 100 may be deeply dyed into the material. If vinyl, the symbol 100 may be printed on the underside of the top of multiple layers of vinyl. Both types of synthetic material may have weathering durability, storable, and portable benefits; and may feature league, sponsor, and partner logos. The ESZ training mat 160 may be placed directly on top of home plate at a baseball field during practice and pre-game warm-up activities or utilized wherever the batter is participating in batting drills including hitting into nets or using heavy-weighted hitting practice baseballs or training area (e.g., multi-sport facility, gym or indoor sport training facility, or the like). The ESZ training mat 160 is a valuable contribution to the safety target and performance training system by building on the educational role of the ESZ home plate. It decreases the amount of confusing, umpire-specific interpretable strike zones, and provides consistent, quality instructional information (graphics and tips) as well as the 3D component described above to permit leagues, coaches, personal trainers, parents, older siblings, and others to help players increase performance. The Expanded Strike Zone Training Mat for Hitters, Pitchers, and Catchers 160 may be used for softball too with the consideration that softball utilizes three different size regulation (11-inch, 12-inch, and 16-inch) balls.

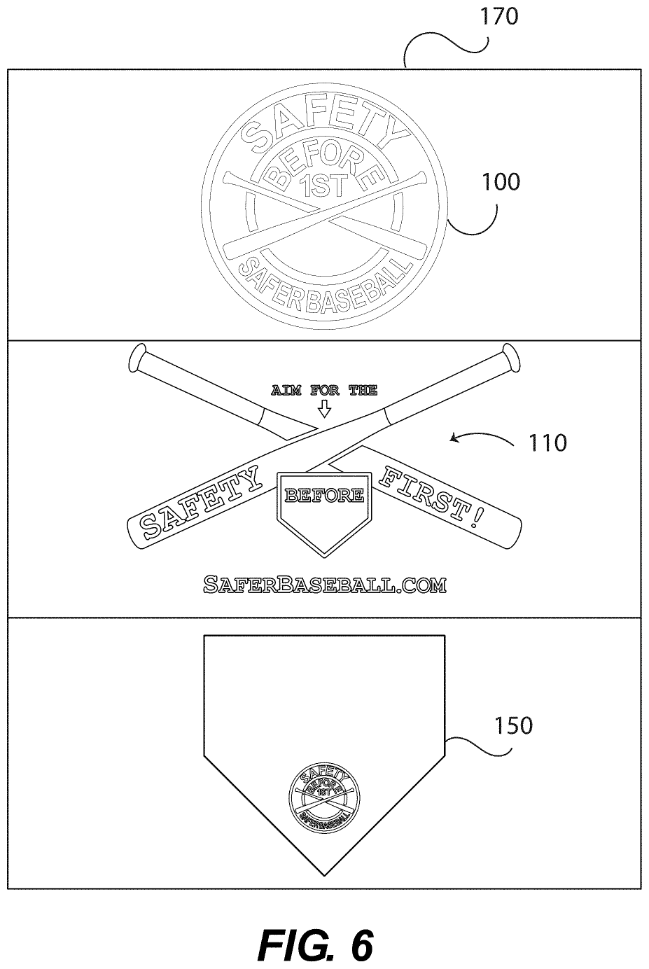

FIG. 6 illustrates downloadable and printable PDF composite 170 with versions of the safety target and performance training system symbol, banner mat, and home plate (100, 110 and 150) shown for example in FIGS. 1, 2, and 5A. Repetition can be the key to success in any sport—especially baseball and softball. The downloadable and printable PDF composite 170 offers several options to utilize components of the safety target and performance training system to permit parents, and all participants, to facilitate away from team or personal coaching and training. Parents can use the safety target and performance training system symbol, banner and synthetic mats, and home plate to reinforce safety and help their child control their actions. The symbol, banner and synthetic mats, and home plate 100, 110 and 150 can be downloaded, printed, and attached (taped, glued, or stapled) to a piece of cardboard and used during parent-child instruction and sibling-sibling play to remind them to always handle their bat and ball safely. Parents can show their child's coach the safety target and performance training system components that are commonly branded and encourage them to contact the provider of these materials to review coach focused materials and offer to join their coach at the next league board meeting to encourage the league to contact the provider of these materials for additional information. The ESZ home plate 155 (shown in FIG. 5B) and ESZ training mat 160 (shown in FIG. 5C) and other safety and training aids may be included in these PDF offerings in the future.

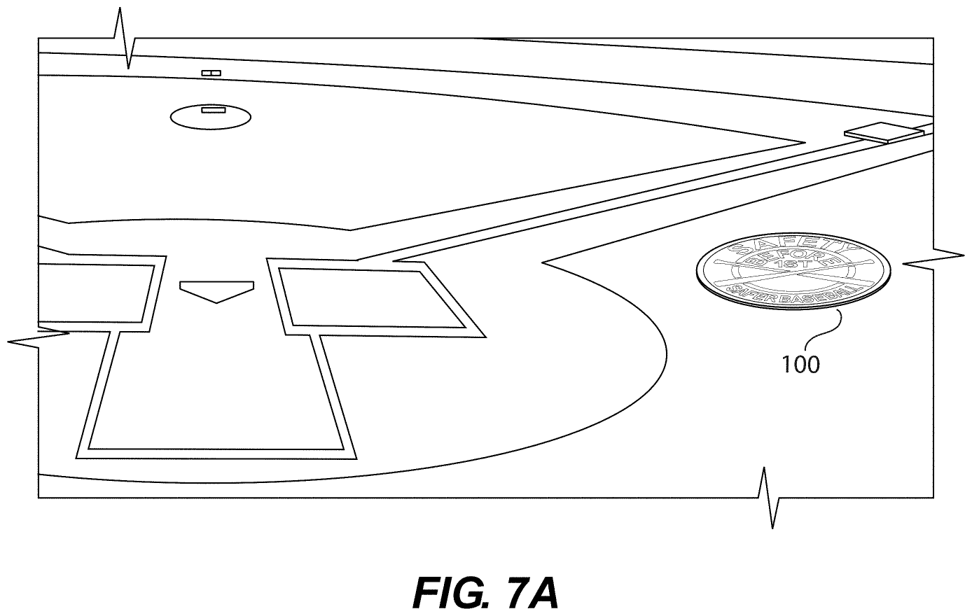

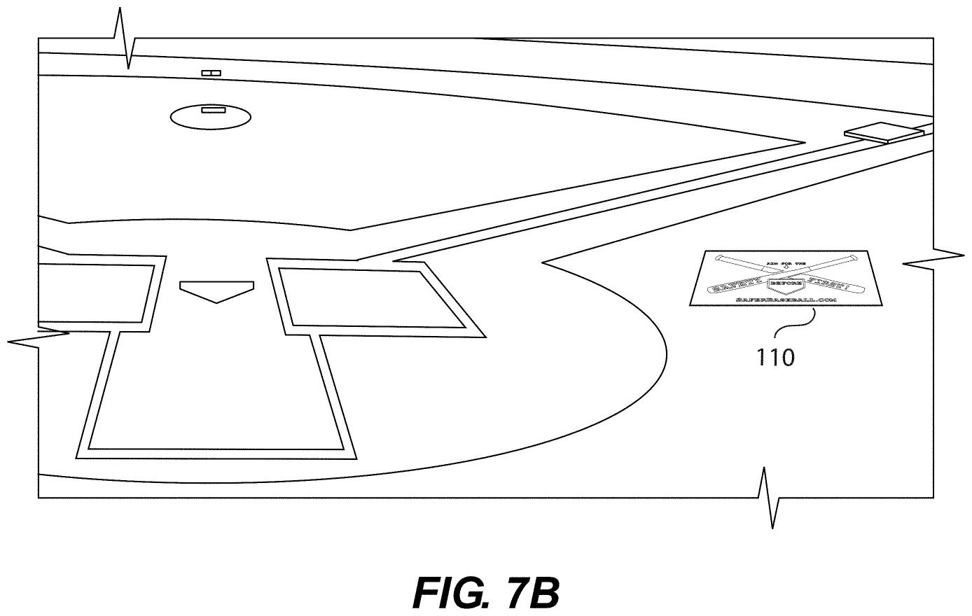

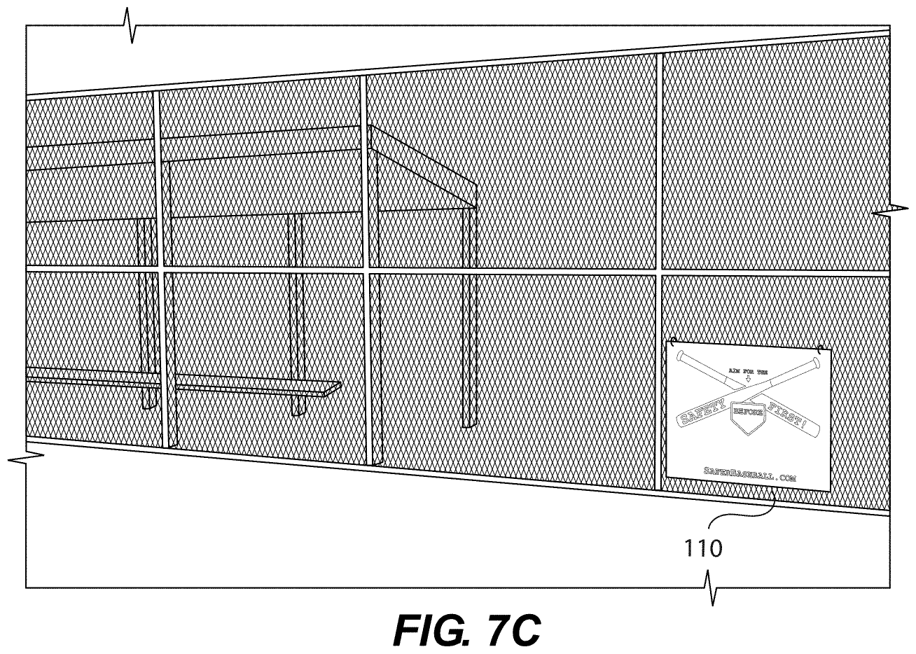

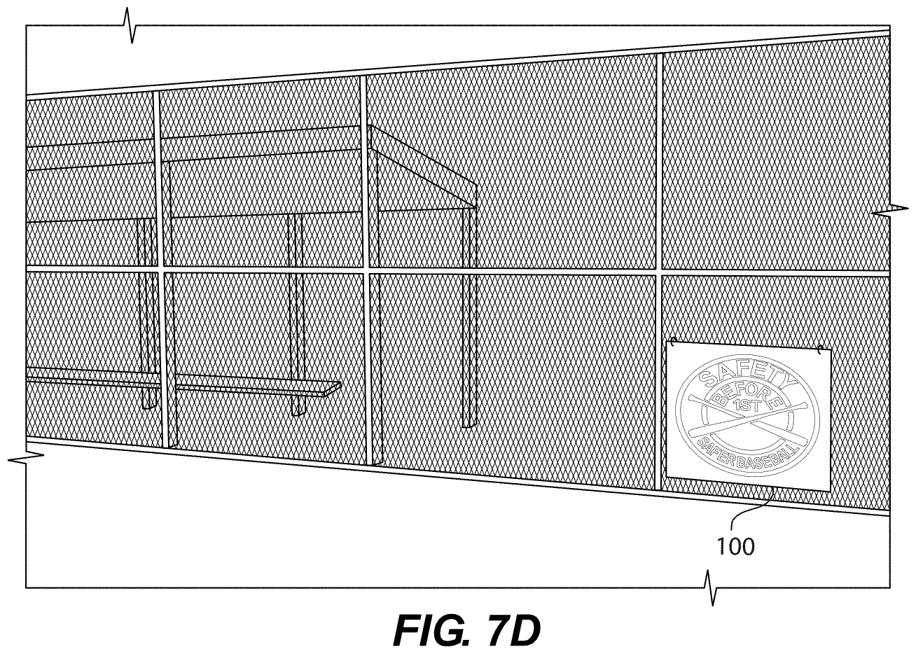

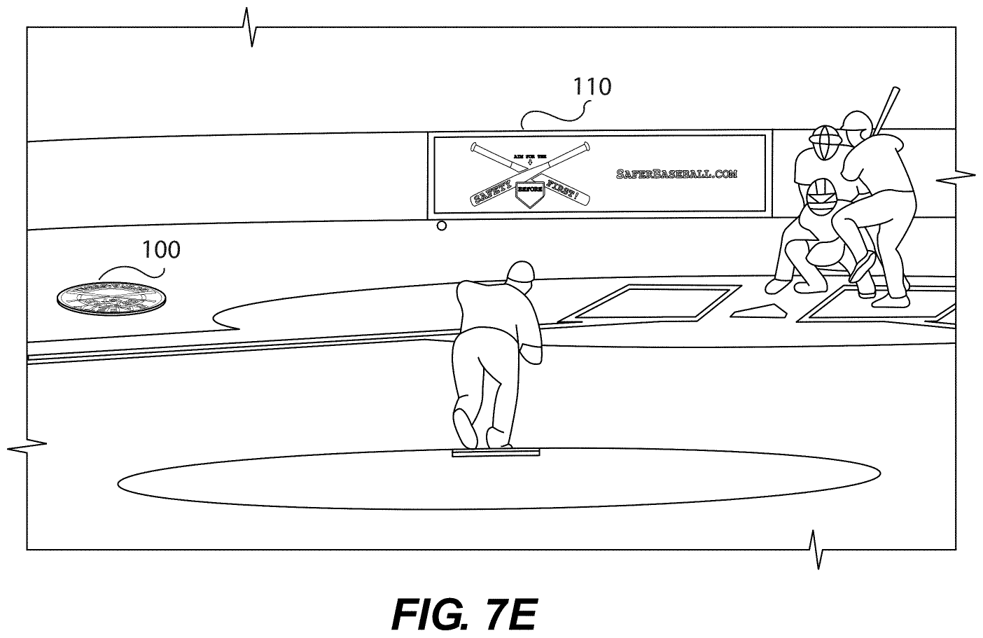

FIGS. 7A-7E illustrate components of the safety target and performance training system and methods as actually and/or virtually deployed on a ball field. Virtual advertising uses the latest technology to place an ad in position to the field of play, regardless of camera motion, and the players movements over the logos. Virtual displays do not interfere with the viewers experience and allows for many brands to put their image into a broadcast and distribute it to a large number of people. As with stencils 130 (shown in FIG. 3), virtual displays promoting advertising and partner programs that benefit the game can be placed adjacent to traditional warm-up circles in foul territory and appear throughout the game. Virtual displays may appear on fencing ad placeholders behind home plate, between home plate and the dugouts, down the foul line or in the outfield, or even on the field (in foul or fair territory) without interfering with participants. Safety target and performance training system virtual displays may, in addition to providing the foregoing training benefits of serving as a visual que to remind players of safety considerations, also generally promote the benefits of safety and performance training throughout baseball and softball.

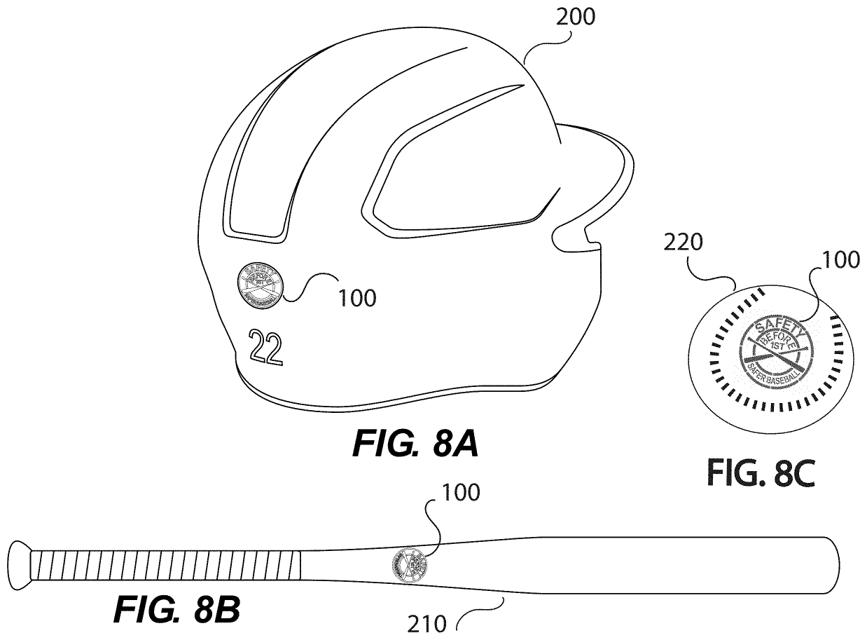

FIG. 8A illustrates a helmet 200 (or possibly a fielder's mask) having a decal/emblem/stamp of the safety target and performance training system symbol 100 (shown in FIG. 1) affixed thereto. FIG. 8B illustrates a baseball bat 210 having a decal/emblem/stamp of the safety target and performance training system symbol 100 (shown in FIG. 1) affixed thereto. The decals or emblems may be affixed using a simple adhesive (sticker) or stamp application, for example. FIG. 8C illustrates a ball 220 having a symbol 100 (shown in FIG. 1) affixed thereto using a stamping method during the manufacturing process or if possible, using a post-manufacturing stamping or adhesive application. Applicant intends to utilize the safety target and performance training system symbol to promote the benefits of bat, helmet, ball, etc. safety throughout baseball and softball by its serving as a visual que to remind players to think of safety and performance.

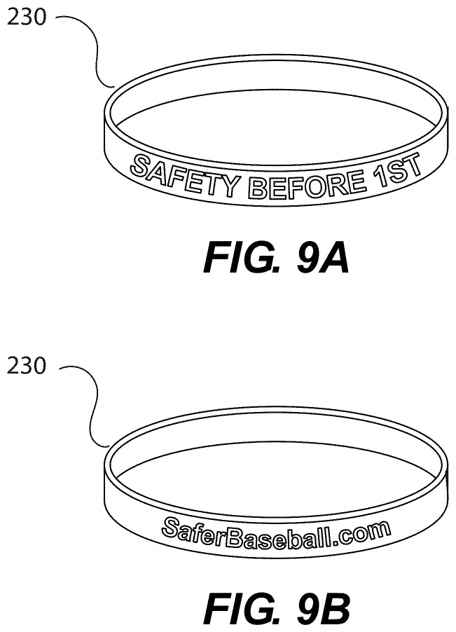

FIGS. 9A and 9B illustrate front and back views of a wristband 230 that may include a safety message and information source identifier that help reinforce a common safety and performance message and visual que promoted by all components of the safety target and performance training system and methods.

The comprehensive nature of the Applicant's standardized safety training and skills development instruction and methods, combined with the ability for leagues, private training facilities, and other partners to customize selected tools and programs offers opportunities to provide a first-of-its-kind certification requirement to clarify and improve the roles of all participants but specifically leagues, coaches, and personal trainers. Helping leagues, other organized programs, and participants prove and promote the attainment of homogenous safety and performance certification attributes could lead to significant decreases in injuries, ill feelings, and potential lawsuits while substantially increasing participation and enjoyment throughout baseball and softball.

As will be understood by those skilled in the art, the invention may be embodied in other specific forms without departing from the spirit or essential characteristics thereof. The elements described above are provided as illustrative examples for implementing the invention. One skilled in the art will recognize that many other implementations are possible without departing from the present invention as recited in the claims. For example, the shapes and sizes, colors or shading, and types of manufacturing materials of various elements of the embodiments of the invention may be changed without departing from the intended scope of the invention. Further, while a home plate is shown in FIG. 5, and a bat, helmet, and ball in FIG. 8, it is appreciated that embodiments of the invention may incorporate other types of sporting equipment, including without limitation elbow guards, batting gloves, shin guards, chest protectors, face masks and shields, gloves, sweatbands, wristbands, and dugout items; safety and training aids; pitching and batting mounds, cages, turf, and matting; coach, umpire, and field equipment; equipment bags, uniforms and other clothing. Accordingly, the disclosure of the present invention is intended to be illustrative, but not limiting, of the scope of the invention. The partnering potential of the safety and performance aspects of the invention offer nearly limitless opportunities to aid and assist other sports, safety, health, performance, training, and lifestyle programs. It is intended that the present invention cover all such modifications and variations of the invention, provided they come within the scope of the appended claims and their equivalents.

What is claimed is:

1. A baseball and/or softball training and performance system disposed on a field or in a training area, comprising:
a home plate disposed on a ground level on the field or in the training area, said home plate having a first graphic and text element communicating a safety and/or performance message and providing a small target symbol; and
a mat or stenciled target disposed on the ground level on the field or in the training area near home plate, said mat or stenciled target having a second graphic and text element communicating a safety and/or performance message and providing a large target symbol relative to the small target symbol,
wherein said first graphic and text element and said second graphic and text element are identical except in size, or wherein said first graphic and text element and said second graphic and text element include a common target symbol.

2. The system of claim 1, further comprising:
a banner disposed within visible range of the home plate, said banner having a third graphic and text element communicating a safety and/or performance message and providing a target symbol,
wherein said second graphic and text element and said third graphic and text element are identical except in size, or wherein said second graphic and text element and said third graphic and text element include a common target symbol.

3. The system of claim 2, wherein the home plate is an expanded strike zone home plate.

4. The system of claim 3, wherein the expanded strike zone home plate includes a plurality of combined ball and arrow graphics, wherein each of said graphics indicates a location for bat contact with a ball to hit the ball in a direction indicated by an arrow.

5. The system of claim 4, wherein the expanded strike zone home plate includes numbered zones.

6. The system of claim 1, wherein the home plate is an expanded strike zone home plate.

7. The system of claim 6, wherein the expanded strike zone home plate includes a plurality of combined ball and arrow graphics, wherein each of said graphics indicates a location for bat contact with a ball to hit the ball in a direction indicated by an arrow.

8. The system of claim 6, wherein the expanded strike zone home plate includes numbered zones.

9. The system of claim 1, further comprising one or more baseball equipment items selected from the group consisting of a helmet, a bat, and a ball, wherein said one or more items include a third graphic and text element communicating a safety and/or performance message and providing a target symbol,
wherein said second graphic and text element and said third graphic and text element are identical except in size, or wherein said second graphic and text element and said third graphic and text element include common target symbol.

10. A baseball and/or softball training and performance set configured to be disposed on a field or in a training area, comprising:
a home plate configured to be disposed on a ground level on the field or in the training area, said home plate having a first graphic and text element communicating a safety and/or performance message and providing a small target symbol; and
a mat or stenciled target configured to be disposed on the ground level on the field or in the training area near home plate, said mat or stenciled target having a second graphic and text element communicating a safety and/or performance message and providing a large target symbol relative to the small target symbol,
wherein said first graphic and text element and said second graphic and text element are identical except in size, or wherein said first graphic and text element and said second graphic and text element include a common target symbol.

11. The set of claim 10, further comprising:
a banner configured to be disposed within visible range of the home plate, said banner having a third graphic and text element communicating a safety and/or performance message and providing a target symbol,
wherein said second graphic and text element and said third graphic and text element are identical except in size, or wherein said second graphic and text element and said third graphic and text element include a common target symbol.

12. The set of claim 11, wherein the home plate is an expanded strike zone home plate.

13. The set of claim 12, wherein the expanded strike zone home plate includes a plurality of combined ball and arrow graphics, wherein each of said graphics indicates a location for bat contact with a ball to hit the baseball in a direction indicated by an arrow.

14. The set of claim 13, wherein the expanded strike zone home plate includes numbered zones.

15. The set of claim 10, wherein the home plate is an expanded strike zone home plate.

16. The set of claim 15, wherein the expanded strike zone home plate includes a plurality of combined ball and arrow graphics, wherein each of said graphics indicates a location for bat contact with a ball to hit the ball in a direction indicated by an arrow.

17. The set of claim 15, wherein the expanded strike zone home plate includes numbered zones.

18. The set of claim 10, further comprising one or more baseball equipment items selected from the group consisting of a helmet, a bat, and a ball, wherein said one or more items include a third graphic and text element communicating a safety and/or performance message and providing a target symbol,
wherein said second graphic and text element and said third graphic and text element are identical except in size, or wherein said second graphic and text element and said third graphic and text element include common target symbol.

19. A method of providing a baseball and/or softball training field or training area, comprising the steps of:
providing a home plate disposed on a ground level on the field or in the training area, said home plate having a first graphic and text element communicating a safety and/or performance message and providing a small target symbol; and
providing a mat or stenciled target disposed on the ground level on the field or in the training area near home plate, said mat or stenciled target having a second graphic and text element communicating a safety and/or performance message and providing a large target symbol relative to the small target symbol,
wherein said first graphic and text element and said second graphic and text element are identical except in size, or wherein said first graphic and text element and said second graphic and text element include a common target symbol.

20. The method of claim 19, further comprising the step of:
providing a banner disposed within visible range of the home plate, said banner having a third graphic and text element communicating a safety and/or performance message and providing a target symbol,
wherein said second graphic and text element and said third graphic and text element are identical except in size, or wherein said second graphic and text element and said third graphic and text element include a common target symbol.
